(19) United States
(12) Patent Application Publication
(10) Pub. No.: US 2022/0144164 A1
(43) Pub. Date: May 12, 2022

(54) NOTIFICATION CONTROL APPARATUS, MOBILE TERMINAL AND NOTIFICATION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kentaro Tani, Yokkaichi-shi, Mie (JP)

(21) Appl. No.: 17/436,919

(22) PCT Filed: Feb. 19, 2020
(86) PCT No.: PCT/JP2020/006392

§ 371 Date: Sep. 7, 2021

(30) Foreign Application Priority Data
Mar. 8, 2019 (JP) 2019-042437

(51) Int. Cl. B60Q 1/50; B60Q 5/00; H04W 4/12; H04W 4/02; H04W 4/40; H04W 4/80; H04W 12/06; H04L 9/40

(52) U.S. Cl. CPC B60Q 1/50; B60Q 5/005; H04W 4/12; H04L 63/0869; H04W 4/40; H04W 4/80; H04W 12/06; H04W 4/023

(57) ABSTRACT

It is made easy for a user to distinguish a vehicle that the user is to board from other vehicles. A notification control apparatus includes a notification drive unit, a communication unit, and a function control unit. The notification drive unit causes a notification unit provided in the vehicle and configured to perform vehicle-side notification that is recognizable from the outside to perform the vehicle-side notification using a first operation pattern. The communication unit transmits a second operation pattern that is associated with the first operation pattern and is provided as a predetermined operation pattern, to a mobile terminal that has a notification function of performing terminal-side notification that uses the predetermined operation pattern. The function control unit controls a function of the communication unit a function of the notification drive unit.

### CROSS-REFERENCE TO RELATED APPLICATIONS

This application is the U.S. national stage of PCT/JP2020/006392 filed on Feb. 19, 2020, which claims priority of Japanese Patent Application No. JP 2019-042437 filed on Mar. 8, 2019, the contents of which are incorporated herein.

### TECHNICAL FIELD

The present disclosure relates to a notification control apparatus, a mobile terminal, and a notification method.

### BACKGROUND

A technique that facilitates the convenience of a user searching for a parked vehicle that the user is to board at night is proposed. In JP 2010-70058A described below, for example, a determination is performed as to whether or not a user carrying a mobile terminal is within a predetermined range from a vehicle that the user is to board. If it is determined that the user is within the range, control is performed so as to turn on the exterior lights provided on the vehicle.

A case is envisioned where the aforementioned control is performed in a plurality of vehicles that different users are to board, and the plurality of vehicles are close to a plurality of those users. It is not necessarily easy for a user in such a case to distinguish the vehicle that the user is to board from other vehicles. This is because the exterior lights are turned on all the vehicles similarly.

In view of this, an object of the present disclosure is to make it easy for a user to distinguish a vehicle that the user is to board from other vehicles.

### SUMMARY

A notification control apparatus according to the present disclosure includes a notification drive unit, a communication unit, and a function control unit. The notification drive unit causes a notification unit provided in a vehicle and configured to perform vehicle-side notification that is recognizable from the outside, to perform the vehicle-side notification using a first operation pattern. The communication unit transmits a second operation pattern that is associated with the first operation pattern and is provided as a predetermined operation pattern, to a mobile terminal that has a notification function of performing terminal-side notification that uses the predetermined operation pattern. The function control unit controls a function of the communication unit and a function of the notification drive unit.

The present disclosure can be realized not only as a notification control apparatus that includes elements for performing such characteristic processing, but can also be realized as a notification control method whose steps serve as such characteristic processing, or as a program that is adopted in order to cause a computer to execute such steps. Moreover, the present disclosure can also be realized as a semiconductor integrated circuit that realizes some or all of the constituent elements that constitute the notification control apparatus, or a notification system that includes the notification control apparatus.

A notification method according to the present disclosure includes: generating a first operation pattern and a second operation pattern in association with each other; causing a notification unit provided in a vehicle and configured to perform vehicle-side notification that is recognizable from the outside, to perform the vehicle-side notification using the first operation pattern; and transmitting the second operation pattern as a predetermined operation pattern to a mobile terminal that has a notification function of performing terminal-side notification that uses the predetermined operation pattern.

A notification method according to the present disclosure can be not only realized as the above-described method for performing such characteristic processing, but can also be realized as a program that is adopted in order to cause a computer to execute such characteristic steps.

### Advantageous Effects of Invention

According to the present disclosure, it is easy for a user to distinguish a vehicle that the user is to board from other vehicles.

### BRIEF DESCRIPTION OF DRAWINGS

FIG. 1 is a block diagram illustrating the configuration of a notification control apparatus according to an embodiment of the present disclosure.

FIG. 2 is a block diagram illustrating the configuration of a mobile device according to an embodiment of the present disclosure.

FIG. 3 is a diagram illustrating a position in the vehicle at which the notification apparatus is disposed.

FIG. 4 is a flowchart illustrating an operation that is performed by the notification control apparatus.

FIG. 5 is a flowchart illustrating an operation that is performed by the mobile device.

FIG. 6 is a flowchart illustrating processing for changing a form of notification in correspondence with a distance.

FIG. 7 is a diagram illustrating terminal-side notification.

FIG. 8 is a diagram illustrating terminal-side notification.

FIG. 9 is a diagram illustrating terminal-side notification.

FIG. 10 is a diagram illustrating terminal-side notification.

### DETAILED DESCRIPTION OF PREFERRED EMBODIMENTS

First, embodiments of the present disclosure will be listed and described. The following describes a notification control apparatus according to the present disclosure.

A notification control apparatus includes a notification drive unit, a communication unit, and a function control unit. The notification drive unit causes a notification unit provided in a vehicle and configured to perform vehicle-side notification that is recognizable from the outside, to perform the vehicle-side notification using a first operation pattern. The communication unit transmits a second operation pattern that is associated with the first operation pattern and is provided as a predetermined operation pattern, to a mobile terminal that has a notification function of performing terminal-side notification that uses the predetermined operation pattern. The function control unit controls a function of the communication unit and a function of the notification drive unit.

The user that is to board the vehicle recognizes the first operation pattern used for terminal-side notification that is performed by the mobile terminal and the second operation pattern used for vehicle-side notification that is performed by the vehicle. The first operation pattern and the second operation pattern are associated with each other, and thus the user can easily distinguish the vehicle that the user is to board, from other vehicles.

“Vehicle-side notification” refers to “notification that is performed by the vehicle”, and hereinafter is also referred to as “first notification”. “Terminal-side notification” refers to “notification that is performed by the mobile terminal”, and hereinafter is also referred to as “second notification”.

A pair of the first operation pattern and the second operation pattern is preferably generated in a random manner. This is because the terminal-side notification (second notification) and the vehicle-side notification (first notification) are performed in different forms for different vehicles, and thus the user can easily distinguish the vehicle that the user is to board from other vehicles.

It is preferable that the communication unit performs communication for performing mutual authentication with the mobile terminal, and the function control unit causes the communication unit to transmit the second operation pattern to the mobile terminal for which the authentication has been achieved. Such processing is advantageous for keeping the user from mistakenly regarding a vehicle that the user is not to board as the vehicle that the user is to board. This is because it is highly likely that the vehicle in which the notification control apparatus that includes the communication unit that has authenticated the mobile terminal and has been authenticated by the mobile terminal is mounted is the vehicle that the user carrying the mobile terminal is to board.

After transmitting the second operation pattern to the mobile terminal, the communication unit preferably transmits, to the mobile terminal, a start trigger, which is an instruction to start the terminal-side notification (second notification) that uses the second operation pattern. This is because such processing is advantageous for synchronizing start of the terminal-side notification (second notification) with start of the vehicle-side notification (first notification).

When a predetermined time has elapsed from when the communication unit transmitted the start trigger to the mobile terminal, the function control unit preferably causes the notification drive unit to end the vehicle-side notification. This is because such processing is advantageous for preventing the vehicle-side notification (first notification) from continuing endlessly.

When the communication unit receives an end instruction from the mobile terminal, the function control unit preferably causes the notification drive unit to end the vehicle-side notification (first notification). It is inferred, based on the terminal-side notification (second notification) being ended, the user has distinguished the vehicle that the user is to board from other vehicles. Ending the notification in this manner is advantageous for discontinuing unnecessary notification.

If a predetermined condition is satisfied in the vehicle, the communication unit preferably transmits, to the mobile terminal, an end trigger that is an instruction to end the terminal-side notification (second notification) that uses the second operation pattern. Furthermore, after the communication unit has transmitted the end trigger to the mobile terminal, the function control unit preferably causes the notification drive unit to end the vehicle-side notification (first notification).

This is because it is inferred that the user has distinguished the vehicle that the user is to board from other vehicles, based on the predetermined condition being satisfied. Ending the notification in this manner is advantageous for discontinuing unnecessary notifications.

There are preferably a plurality of types of second operation patterns in accordance with a distance between the notification control apparatus and the mobile terminal. When the vehicle that the user is to board is arranged, such a configuration is advantageous for the user to be able to recognize that the user is close to the vehicle even if the vehicle cannot be visually recognized.

In addition, a mobile terminal according to the present disclosure includes a second communication unit configured to receive the second operation pattern from the notification control apparatus according to the present disclosure, a second notification unit configured to perform the terminal-side notification (second notification) using a predetermined operation pattern, a second notification drive unit configured to cause the second notification unit to perform the terminal-side notification (second notification) using the second operation pattern as the predetermined operation pattern, and a second function control unit configured to control a function of the second communication unit and a function of the second notification drive unit. The mobile terminal according to the present disclosure performs the terminal-side notification (second notification).

It is preferable that there are a plurality of types of second operation patterns in accordance with a distance between the vehicle and the mobile terminal, and the second notification drive unit causes the second notification unit to perform the terminal-side notification (second notification) that uses the second operation pattern selected from the plurality of types in accordance with the distance. When the vehicle that the user is to board is arranged, such a configuration is advantageous for the user to be able to recognize that the user is close to the vehicle even if the vehicle cannot be visually recognized.

A notification method according to the present disclosure includes: generating a first operation pattern and a second operation pattern in association with each other; causing a notification unit provided in a vehicle and configured to perform vehicle-side notification (first notification) that is recognizable from the outside, to perform the vehicle-side notification (first notification) using the first operation pattern; and transmitting the second operation pattern as a predetermined operation pattern to a mobile terminal that has a notification function of performing terminal-side notification (second notification) that uses the predetermined operation pattern. With the notification method, it is easy for a user to distinguish a vehicle that the user is to board from other vehicles.

Specific examples of a notification control apparatus, a mobile terminal, and a notification method according to the present disclosure will be described below with reference to drawings. Note that the present disclosure is not limited to illustrations of these, but is indicated by the claims, and is intended to include all modifications that are within the meanings and the scope that are equivalent to those of the claims.

At least some of the embodiments described below may be suitably combined

Each apparatus in the embodiments of the present disclosure includes a computer constituted by a microprocessor, a ROM, a RAM, and so on.

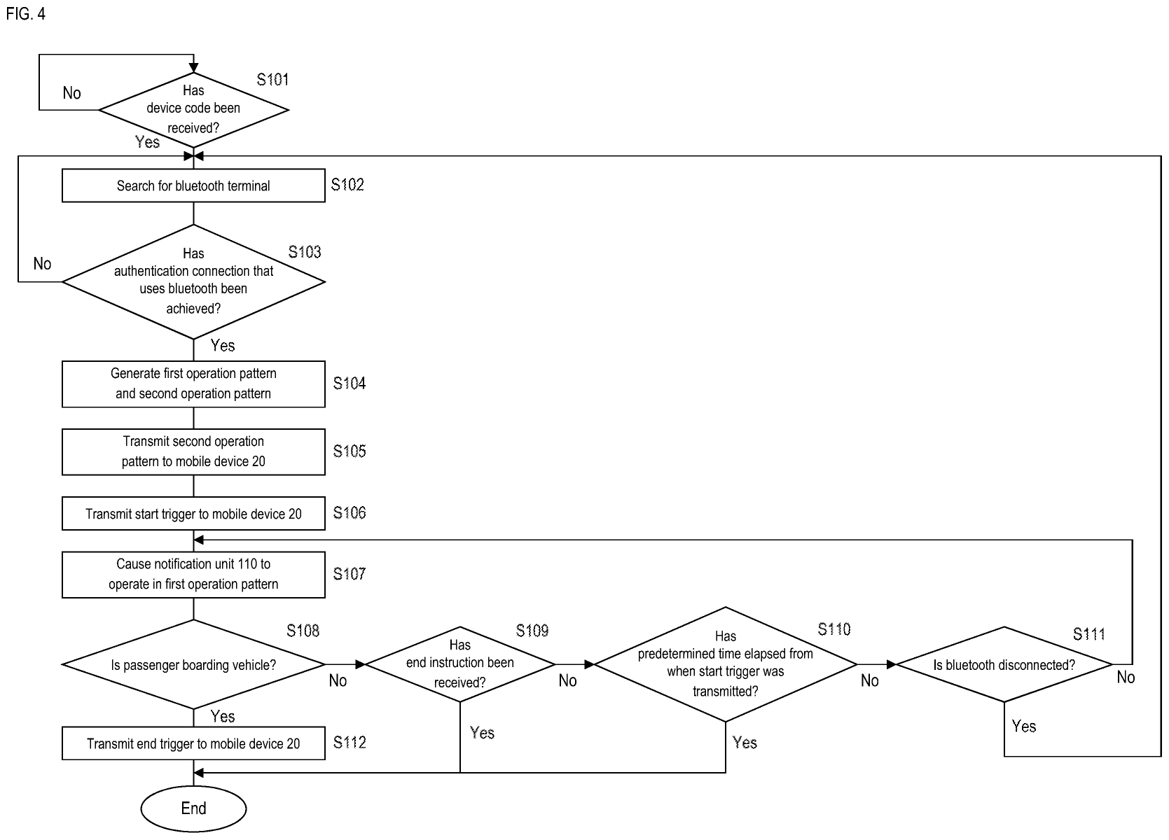

A computation processing unit such as a microprocessor reads out computer programs that each include some or all of the steps in the flowcharts shown in FIGS. 4 to 6, from a storage unit such as a ROM or a RAM, and executes the programs.

These computer programs can be installed from an external server apparatus or the like. In addition, the computer programs of a plurality of apparatuses are each distributed in a state in which they are stored in a recording medium such as a CD-ROM, a DVD-ROM, or a semiconductor memory.

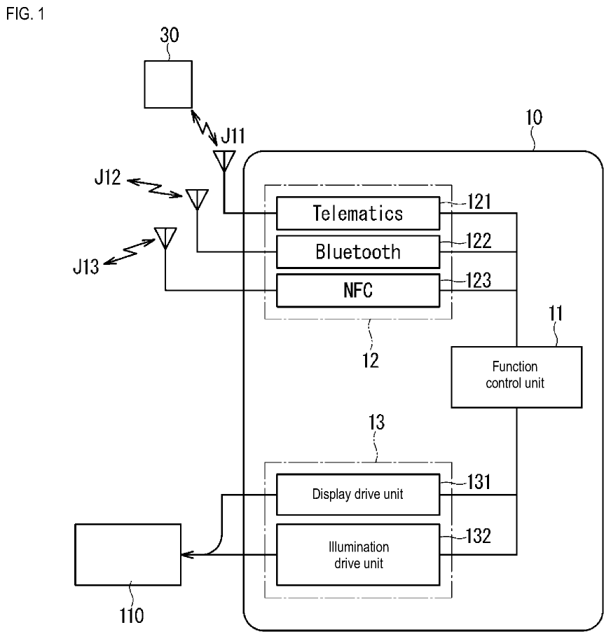

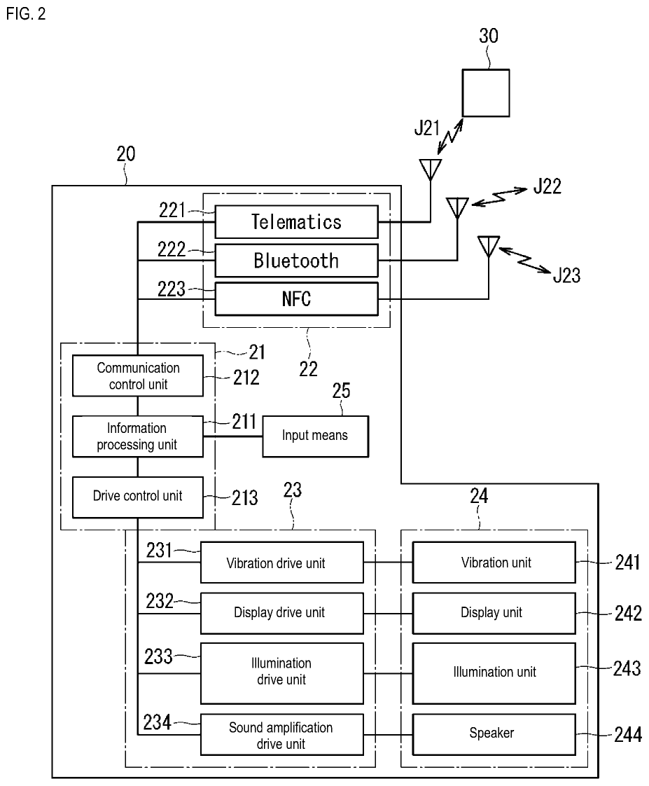

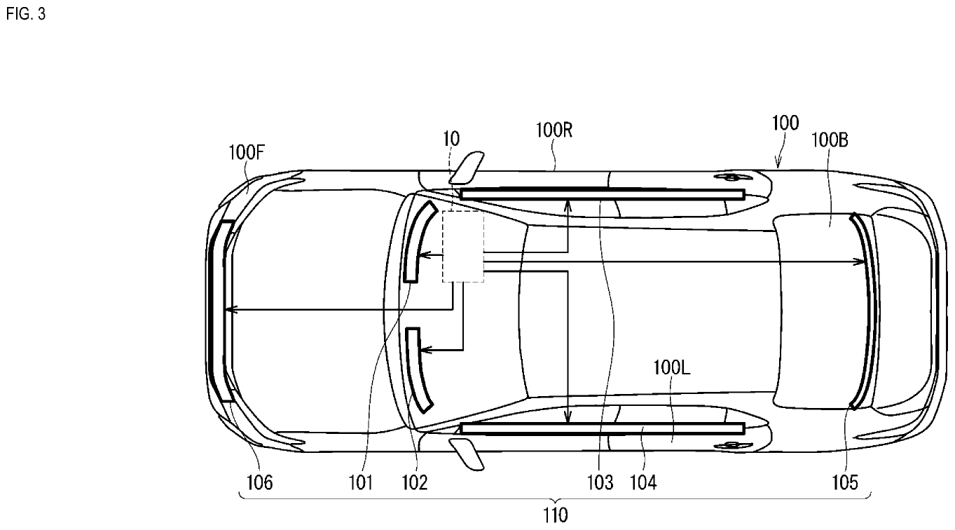

A notification control apparatus, a mobile terminal, and a notification method according to the present disclosure will be described below. FIG. 1 is a block diagram illustrating the configuration of a notification control apparatus 10. FIG. 2 is a block diagram illustrating the configuration of a mobile device 20. FIG. 3 is a diagram illustrating a position in a vehicle 100 at which a notification unit 110 is disposed.

The notification control apparatus 10 includes a function control unit 11, a communication unit 12, and a notification drive unit 13. The function control unit 11 controls the function of the communication unit 12 and the function of the notification drive unit 13 (see FIG. 1). The function control unit 11 generates a first operation pattern and a second operation pattern in association with each other.

A mobile device 20 has a notification function of performing terminal-side notification (second notification) that uses a predetermined operation pattern. The mobile device 20 has a notification function. The notification function is a function of performing terminal-side notification (second notification). The terminal-side notification (second notification) uses a predetermined operation pattern. The mobile device 20 includes a function control unit 21, a communication unit 22, a notification unit 24, and a notification drive unit 23. The function control unit 21 controls the function of the communication unit 22 and the function of the notification drive unit 23. The notification unit 24 performs the terminal-side notification (second notification) using the predetermined operation pattern (see FIG. 2). The mobile device 20 can be realized using a mobile terminal that is illustrated as a smartphone.

The communication unit 12 transmits, to the mobile device 20, the second operation pattern that is provided as the predetermined operation pattern. The communication unit 22 receives the second operation pattern. The communication unit 12 includes a communication circuit 122 (indicated by “Bluetooth (registered trademark, the same applies hereafter)” in FIG. 1) that performs, for example, communication that complies with IEEE802.15.1 such as communication J12 that uses Bluetooth. The communication unit 22 includes a communication circuit 222 (indicated by “Bluetooth” in FIG. 2) that performs communication J22 that uses Bluetooth, for example. The second operation pattern is transmitted from the communication unit 12 to the communication unit 22 through the communication J12 and communication J22 (see FIGS. 1 and 2).

The notification drive unit 23 causes the notification unit 24 to perform the terminal-side notification (second notification) using the second operation pattern as the predetermined operation pattern.

The notification unit 110 is provided in the vehicle 100, and performs vehicle-side notification (first notification) that is recognizable from the outside. The notification unit 110 is provided in the vehicle 100. The notification unit 110 performs vehicle-side notification (first notification). Vehicle-side notification (first notification) is recognizable from the outside. The notification drive unit 13 causes the notification unit 110 to perform the vehicle-side notification (first notification) using the first operation pattern (see FIGS. 1 and 3).

The notification control apparatus 10 is mounted in the vehicle 100. The notification control apparatus 10 can be accommodated in a console box of the vehicle 100, for example. In order to avoid the drawing being complicated, FIG. 3 does not show the console box, and such accommodation is expressed by the notification control apparatus 10 being outlined with hidden object lines (broken lines).

FIG. 3 illustrates that the notification unit 110 includes a plurality of notification elements 101 to 106. The notification unit 110 does not necessarily include all of these notification elements 101 to 106. Control that is performed by the notification drive unit 13 so as to cause the notification unit 110 to perform vehicle-side notification (first notification) using the first operation pattern is indicated by arrows directed from the notification control apparatus 10 to the notification elements 101 to 106.

The notification element 101 is a console display, for example. The notification element 102 may be a display apparatus that is retrofitted in the interior of the vehicle 100, for example. The notification element 103 may be a display apparatus provided outward of a right door 100R of the vehicle 100, for example. The notification element 104 may be a display apparatus provided outward of a left door 100L of the vehicle 100, for example. The notification element 105 may be a display apparatus provided on a back seat 100B of the vehicle 100 or in the vicinity thereof, for example. The notification element 106 may be a display apparatus provided on the bumper 100F on the front side of the vehicle 100 or in the vicinity thereof, for example.

The user that is to board the vehicle 100 carries the mobile device 20. When the user can visually recognize the vehicle 100, the user recognizes the second operation pattern that is used for the terminal-side notification (second notification) performed by the mobile device 20 and the first operation pattern that is used for the vehicle-side notification (first notification) performed by the vehicle 100. The first operation pattern and the second operation pattern are associated with each other, and thus the user can easily distinguish the vehicle that the user is to board from other vehicles.

A case is envisioned in which, for example, the terminal-side notification (second notification) adopts a form of vibration, and the vehicle-side notification (first notification) adopts a form of illumination. The user recognizes that the mobile device 20 vibrates, and visually recognizes the vehicle 100 that performs illumination in a pattern associated with this vibrating pattern. This illumination is performed by the notification unit 110. Various forms of association between the first operation pattern and the second operation pattern are conceivable, and a detailed description thereof will be given later.

Random generation of a pair of the first operation pattern and the second operation pattern, for example, generation of a pair for which the form of association between the first operation pattern and the second operation pattern randomly changes is advantageous for performing the terminal-side notification (second notification) and the vehicle-side notification (first notification) in a form that differs for each vehicle. This is because this way, the user can more easily distinguish the vehicle that the user is to board from other vehicles.

The communication unit 12 transmitting the second operation pattern to a mobile device 20 that has authenticated the communication unit 12 and has been authenticated by the communication unit 12 is advantageous for keeping the user from mistakenly recognizing a vehicle that the user is not to board as the vehicle that the user is to board. This is because it is highly likely that the vehicle 100 in which the notification control apparatus 10 that includes the communication unit 12 that has authenticated the mobile device 20 and has been authenticated by the mobile device 20 is mounted is the vehicle 100 that the user carrying the mobile device 20 is to board.

A known technique can be applied to such a mutual authentication technique. The communication circuits 122 and 222 can perform the aforementioned authentication through the communication J12 and the communication J22 using Bluetooth, for example.

### Start of Notification Control

In the notification control apparatus 10, the communication unit 12 includes the communication circuit 121 (indicated by “Telematics” in FIG. 1) that is used for communication that complies with Telematics. The communication circuit 121 transmits/receives a signal to/from a communication center 30 through communication J11.

In the mobile device 20, the communication unit 22 includes the communication circuit 221 (indicated by “Telematics”) that is used for communication that complies with Telematics. The communication circuit 221 transmits/receives a signal to/from the communication center 30 through the communication J21.

The communication center 30 transmits/receives a signal through communication that complies with Telematics. The notification control apparatus 10 and the mobile device 20 transmit/receive a signal to/from each other via the communication center 30 through the communication J11 and the communication J21. The technique for receiving a signal through communication that complies with Telematics is known, and thus a detailed description of such a technique is omitted.

The function control unit 21 includes a communication control unit 212, an information processing unit 211, and a drive control unit 213. The communication control unit 212 controls the function of the communication unit 22. The communication control unit 212 mediates transfer of information between the communication unit 22 and the information processing unit 211. The drive control unit 213 controls the function of the notification drive unit 23.

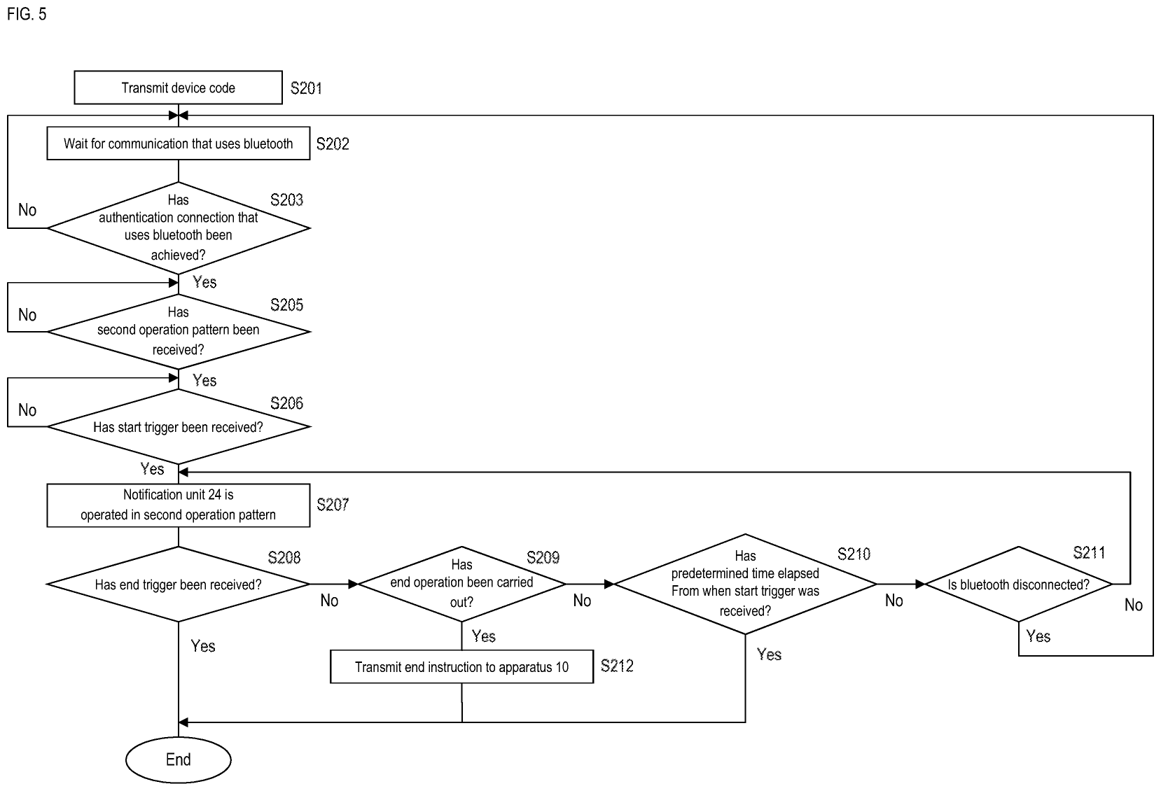

FIG. 4 is a flowchart illustrating the operation that is performed by the notification control apparatus 10. FIG. 5 is a flowchart illustrating the operation that is performed by the mobile device 20.

As shown in FIG. 5, in step S201, the mobile device 20 transmits a code (in FIGS. 4 and 5 and hereinafter, referred to as “device code”) for specifying the mobile device 20, to the communication center 30 through the communication J21. Such transmission is executed under control of the function control unit 21, or more specifically under control of the communication control unit 212 by the communication unit 22, or more specifically by the communication circuit 221.

After step S201 is executed, steps S202 and S203 are executed. In step S202, the mobile device 20 waits for communication that uses Bluetooth, and further determines in step S203 whether or not an authentication connection that uses Bluetooth has been achieved. Here, “authentication connection” refers to an event where the notification control apparatus 10 and the mobile terminal (in FIG. 5, the mobile device 20) achieve mutual authentication through communication. The authentication connection in step S203 uses Bluetooth, and thus a determination is performed as to whether or not an authentication connection that is made through the communication J12 and the communication J22 has been achieved.

Step S202 is executed under control of the function control unit 21, or more specifically under control of the communication control unit 212 by the communication unit 22, or more specifically by the communication circuit 222. The determination in step S203 is executed by the function control unit 21, or more specifically by the communication control unit 212.

If the result of the determination in step S203 is “yes”, in other words, if authentication connection has been achieved, then the procedure advances to step S205. If the result of the determination is “no”, then steps S202 and S203 are repeatedly executed.

As shown in FIG. 4, the notification control apparatus 10 determines in step S101 whether or not a device code has been received. The device code is received from the communication center 30 through the communication J11. The device code is received under control of the function control unit 11 by the communication unit 12, or more specifically by the communication circuit 121. A case is envisioned and described below where the device code transmitted in step S201 has been received.

When the device code is received, the result of determination in step S101 is “yes”, and steps S102 and S103 are executed. Step S101 is repeatedly executed until the determination in step S101 is “yes”.

In step S102, the notification control apparatus 10 searches for a mobile terminal (indicated by “Bluetooth terminal” in FIG. 4) that performs communication using Bluetooth. Such search is a known technique, and thus a detailed description of this technique is omitted. Step S102 is executed under control of the function control unit 11 by the communication unit 12, more specifically by the communication circuit 122.

In step S103, a determination is performed as to whether or not authentication connection that uses Bluetooth has been achieved. The determination in step S103 is performed by the function control unit 11.

Achievement of such authentication connection is conditioned on that the mobile terminal found in step S102 is the mobile device 20 that has transmitted the device code received in step S101. When authentication connection with the mobile device 20 for which the above condition is satisfied is achieved, the result of the determination in step S103 is “yes”, and the procedure advances to step S104. If the result of the determination is “no”, steps S102 and S103 are repeatedly executed.

In step S104, the first operation pattern and the second operation pattern are generated in association with each other. Step S104 is executed by the function control unit 11.

After step S104 is executed, processing for transmitting the second operation pattern to the mobile device 20 is executed in step S105. Step S105 is executed under control of the function control unit 11 by the communication unit 12, more specifically by the communication circuit 122. The second operation pattern is transmitted through the communication J12.

After step S105 is executed, processing for transmitting a start trigger to the mobile device 20 is executed in step S106. The start trigger is information for instructing start of the terminal-side notification (second notification) that uses the second operation pattern and is performed by the mobile device 20. Step S106 is executed under control of the function control unit 11 by the communication unit 12, more specifically by the communication circuit 122. The start trigger is transmitted through the communication J12.

After step S106 is executed, processing for causing the notification unit 110 to operate in the first operation pattern is executed in step S107. Step S107 is executed by the notification drive unit 13 driving the notification unit 110 under control of the function control unit 11. The vehicle-side notification (first notification) is realized by executing step S107.

As shown in FIG. 5, the mobile device 20 determines in step S205 whether or not the second operation pattern has been received. The second operation pattern is received by the communication circuit 222 through the communication J22. If the result of the determination in step S205 is “no”, step S205 is repeatedly executed. When the second operation pattern is received, the result of the determination is “yes”, and step S206 is executed. The determination in step S205 is executed by the communication control unit 212 and the information processing unit 211. More specifically, a signal included in the communication J22 is transmitted from the communication control unit 212 to the information processing unit 211, and the information processing unit 211 determines whether or not the signal includes the second operation pattern.

The mobile device 20 determines in step S206 whether or not a start trigger has been received. The start trigger is received by the communication circuit 222 through the communication J22. If the result of the determination in step S206 is “no”, step S206 is repeatedly executed. When the start trigger is received, the result of the determination is “yes”, and step S207 is executed. The determination in step S206 is executed by the communication control unit 212 and the information processing unit 211. More specifically, a signal included in the communication J22 is transmitted from the communication control unit 212 to the information processing unit 211, and the information processing unit 211 determines whether or not the signal includes the start trigger.

In step S207, processing for causing the notification unit 24 to operate in the second operation pattern is executed. Step S207 is executed by the notification drive unit 23 driving the notification unit 24 under control of the function control unit 21. The terminal-side notification (second notification) is realized by executing step S207.

Synchronizing start of the terminal-side notification (second notification) with start of the vehicle-side notification (first notification) is more effective than the terminal-side notification and the vehicle-side notification not being synchronized. This is because, also if the vehicle-side notification (first notification) cannot be recognized when the terminal-side notification (second notification) is executed by the mobile device 20 carried by the user, and also if the vehicle-side notification (first notification) is recognized without the terminal-side notification (second notification) being executed by the mobile device 20 carried by the user, it is difficult for the user to distinguish the vehicle that the user is to board from other vehicles.

Synchronizing start of the terminal-side notification (second notification) with start of the vehicle-side notification (first notification) is also advantageous for the user to easily recognize the association between the first operation pattern and the second operation pattern. This is because, although an example of such association will be described later, if the association between the first operation pattern and the second operation pattern depends on time similarity, the time difference between start of the terminal-side notification (second notification) and start of the vehicle-side notification (first notification) causes a difficulty in distinguishing the vehicle that the user is to board from other vehicles.

Executing steps S106 and S206 using the start trigger is advantageous for synchronizing start of the terminal-side notification (second notification) with start of the vehicle-side notification (first notification). Executing steps S106 and S107 in parallel is more advantageous.

In order to take consideration of the processing time for performing the terminal-side notification (second notification) using the second operation pattern as the predetermined operation (step S207) after the second operation pattern is received by the mobile device 20 (step S205), a predetermined time may also be provided from when step S105 is executed until step S106 is executed.

### End of Notification Control (I)

As shown in FIG. 4, after step S107 is executed, a determination is performed in step S108 whether or not a predetermined condition is satisfied. If the determination in step S107 is “yes”, in other words, if the predetermined condition is satisfied, step S112 is executed. If the determination in step S107 is “no”, in other words, the predetermined condition is not satisfied, step S109 is executed.

An event where a vehicle that a user is to board is recognized by the user, and the user boards the vehicle is adopted as the predetermined condition, for example. Such an event is abbreviated as “passenger is boarding vehicle” in FIG. 4.

Such an event can be realized using a known technique, for example, short-range wireless communication (Near Field Communication: hereinafter abbreviated as “NFC”). NFC can be realized through communication J13 and communication J23, for example. The communication J13 is executed by a communication circuit 123 (indicated by “NFC” in FIG. 1) under control of the function control unit 11. The communication J23 is executed by a communication circuit 223 (indicated by “NFC” in FIG. 2) under control of the communication control unit 212.

In step S112, processing for transmitting an end trigger to the mobile device 20 is executed. The end trigger is information for performing an instructing to end the terminal-side notification (second notification) that uses the second operation pattern and is performed by the mobile device 20.

Step S112 is executed under control of the function control unit 11 by the communication unit 12, or more specifically by the communication circuit 122. The end trigger is transmitted through the communication J12. After step S112 is executed, the vehicle-side notification (first notification) ends. The function control unit 11 causes the notification drive unit 13 to end the vehicle-side notification (first notification) that is executed by the notification unit 110.

As shown in FIG. 5, after step S207 is executed, the mobile device 20 determines in step S208 whether or not the end trigger has been received. The end trigger is received by the communication circuit 222 through the communication J22. If the result of the determination in step S208 is “no”, step S209 is executed. If the end trigger is received, the result of the determination is “yes”, and the terminal-side notification (second notification) ends.

The determination in step S208 is executed by the communication control unit 212 and the information processing unit 211. More specifically, a signal included in the communication J22 is transmitted from the communication control unit 212 to the information processing unit 211, and the information processing unit 211 determines whether or not the signal includes the end trigger.

If the information processing unit 211 determines that the signal includes the end trigger, the information processing unit 211 instructs that the drive control unit 213 cause the notification drive unit 23 to end the terminal-side notification (second notification) that is executed by the notification unit 24.

Thus, as a result of the predetermined condition being satisfied in the vehicle 100, the vehicle-side notification (first notification) is ended. In addition, as a result of the predetermined condition being satisfied in the vehicle 100, the terminal-side notification (second notification) is ended using the end trigger. This is because it is inferred that the user has distinguished the vehicle that the user is to board from other vehicles, based on the predetermined condition being satisfied. Ending notification in this manner is advantageous for discontinuing unnecessary notification.

### End of Notification Control (II)

As shown in FIG. 5, in step S209, a determination is performed as to whether or not to end the terminal-side notification (second notification), or the terminal-side notification (second notification) and vehicle-side notification (first notification). When the user distinguishes the vehicle that the user is to board from other vehicles, for example, the above notification is ended by the user operating the mobile device 20. In step S209, a determination is performed as to whether or not such an operation has been performed. In drawings, a criterion for such determination is abbreviated as “has end operation been carried out?”.

The operation can be executed by the user inputting information using input means 25. The input means 25 is provided on the mobile device 20, and transmits the information input by the user to the information processing unit 211. The information processing unit 211 instructs that the drive control unit 213 causes the notification drive unit 23 to end the terminal-side notification (second notification) that is being executed by the notification unit 24.

The user inputting information using the input means 25 can be easily realized, for example, using an application on a normal smartphone, and thus a detailed description thereof is omitted.

If the result of the determination in step S209 is “no”, step S210 is executed. If the result of the determination in step S209 is “yes”, step S212 is executed. In step S212, processing for transmitting an end instruction to the notification control apparatus 10 is executed. The end instruction is information for instructing that the vehicle-side notification (first notification) that uses the first operation pattern and is being performed by the vehicle 100 be ended.

Step S212 is executed by the communication unit 22 under control of the function control unit 21, more specifically by the communication circuit 222 under control of the communication control unit 212. The end instruction is transmitted through the communication J22. After step S212 is executed, the terminal-side notification (second notification) ends.

As shown in FIG. 4, the vehicle 100 determines in step S109 whether or not the end instruction has been received. The end instruction is received by the communication circuit 122 through the communication J12. If the result of the determination in step S109 is “no”, step S110 is executed. If the end instruction has been received, the result of the determination is “yes”, and the vehicle-side notification (first notification) ends.

The determination in step S109 is executed by the communication unit 12 and the function control unit 11. More specifically, a signal included in the communication J12 is transmitted from the communication circuit 122 to the function control unit 11, and the function control unit 11 determines whether or not the signal includes the end instruction.

If the function control unit 11 determines that the signal includes the end instruction, the function control unit 11 causes the notification drive unit 13 to end the vehicle-side notification (first notification) that is being executed by the notification unit 110.

The terminal-side notification (second notification) is ended in the mobile device 20 in this manner, and the vehicle-side notification (first notification) is ended using the end instruction. This is because it is inferred that the user has distinguished the vehicle that the user is to board from other vehicles, based on the terminal-side notification (second notification) being ended in the mobile device 20. Ending notification in this manner is advantageous for discontinuing unnecessary notification.

### End of Notification Control (III)

As shown in FIG. 4, in step S110, a determination is performed as to whether or not a predetermined time has elapsed from when the start trigger was transmitted. Such a determination is executed by the communication unit 12 (more specifically, the communication circuit 122) and the function control unit 11 in cooperation. If the result of the determination is “no”, step S111 is executed.

If the result of the determination is “yes”, the vehicle-side notification (first notification) ends. This is processing for preventing the vehicle-side notification (first notification) from continuing endlessly.

As shown in FIG. 5, in step S210, a determination is performed as to whether or not a predetermined time has elapsed from when the start trigger was received. Such a determination is executed by the communication unit 22 (more specifically, the communication circuit 222) and the function control unit 21 (more specifically, the communication control unit 212) in cooperation. If the result of the determination is “no”, step S211 is executed.

If the result of the determination is “yes”, the terminal-side notification (second notification) ends. This is processing for preventing the terminal-side notification (second notification) from continuing endlessly.

### Update of Communication

As shown in FIG. 4, in step S111, a determination is performed as to whether or not the communication J12 that uses Bluetooth has been disconnected. An event may occur where the communication J12 is unintentionally disconnected depending on the communication environment, and a determination is performed as to whether or not such an event has occurred. Alternatively, a determination may also be performed in consideration of an event where the communication J12 is intentionally disconnected.

In FIG. 4, a criterion for such a determination is abbreviated as “has Bluetooth been disconnected?”. Such a determination is executed by the communication unit 12 (more specifically, the communication circuit 122) and the function control unit 11 in cooperation.

If the communication J12 is not disconnected, the result of the determination is “no”, and the procedure returns to step S107. The flow of this processing is a flow of processing for continuing the vehicle-side notification (first notification).

If the communication J12 is disconnected, the result of the determination is “yes”, and the procedure returns to step S102. The flow of this processing is a flow of processing for achieving authentication connection with the mobile terminal (including the mobile device 20) again.

As shown in FIG. 5, in step S211, a determination is performed as to whether or not the communication J22 that uses Bluetooth is disconnected. An event may occur where the communication J22 is unintentionally disconnected depending on a communication environment, and a determination is performed as to whether or not such an event has occurred. Alternatively, a determination may also be performed in consideration of an event where the communication J22 is intentionally disconnected.

In FIG. 5, a criterion for such a determination is abbreviated as “is Bluetooth disconnected?”. Such a determination is executed by the communication unit 22 (more specifically, the communication circuit 222) and the function control unit 21 (more specifically, the communication control unit 212) in cooperation.

If the communication J22 is not disconnected, the result of the determination is “no”, and the procedure returns to step S207. The flow of this processing is a flow of processing for continuing the terminal-side notification (second notification).

If the communication J22 is disconnected, the result of the determination is “yes”, and the procedure returns to step S202. The flow of this processing is a flow of processing for achieving authentication connection with the notification control apparatus 10 again.

Such update of communication is advantageous for maintaining the effect of making it easy for the user to distinguish the vehicle that the user is to board from other vehicles.

### Take as Notification Method

The above-described operation of the notification control apparatus 10 is coordinated with the operation of the mobile device 20 and can be regarded as a notification method. Specifically, the notification method can be expressed as including:

step S104 for generating a first operation pattern and a second operation pattern in association;

step S107 for causing the notification unit 110 that is provided in the vehicle 100 and performs vehicle-side notification (first notification) that is recognizable from the outside, to perform vehicle-side notification (first notification) using a first operation pattern; and

step S105 for transmitting a second operation pattern as a predetermined operation pattern to the mobile device 20 that has a notification function of performing terminal-side notification (second notification) that uses the predetermined operation pattern.

It is apparent that the user can easily distinguish the vehicle that the user is to board from other vehicles using the notification method, based on the above description of the operation of the notification control apparatus 10 and the operation of the mobile device 20.

### Use of Present Embodiment in Various Situations

A situation is envisioned where, when a large number of vehicles are parked closely, the user distinguishes the vehicle that the user is to board from other vehicles from among the large number of vehicles.

Also, a situation is envisioned where, when the vehicle that the user is to board is to be allocated, the user distinguishes the vehicle that the user is to board from other vehicles. A case is also envisioned where, when the vehicle is to be allocated, the vehicle travels toward the user through automated driving.

In any of the above situations, applying the present embodiment is advantageous for distinguishing the vehicle.

### Illustration of First Operation Pattern

As described above, the first operation pattern is adopted for vehicle-side notification (first notification). As shown in FIG. 3, the notification unit 110 of the vehicle 100 includes the notification elements 101 to 106. In view of this, various forms of first operation pattern can be envisioned.

When visual notification is performed, for example, one of or both a color and a texture (hereinafter tentatively referred to as “color and/or texture”) can be displayed by the notification unit 110. The color and/or texture may or may not change over time. If the color and/or texture changes over time, such temporal change is also a portion of the first operation pattern.

Differences in brightness can be grasped as one of or both the difference in color and the difference in texture. “Texture” may also include any of text, symbols, or pictorial symbols.

A console display may be adopted as the notification element 101, for example, and this console display displays the color and/or texture in accordance with the first operation pattern. A display apparatus retrofitted in the interior of the vehicle 100 may be adopted as the notification element 102, and this display apparatus displays the color and/or texture.

Such display in the interior of the vehicle 100 is driven by a display drive unit 131, for example (see FIG. 1). The display drive unit 131 is included in the notification drive unit 13. The function of the display drive unit 131 is controlled by the function control unit 11.

Alternatively, visual notification performed using headlights and/or taillights usually provided on the vehicle 100 can be adopted as the vehicle-side notification (first notification). Regarding visual notification performed using the headlights and/or taillights, it is suitable to avoid a situation where the headlights and/or taillights are exerting their original function, for example, a situation where the vehicle 100 is travelling. Such visual notification is suitable for a situation where the vehicle 100 is parked, and the user wants to distinguish the vehicle that the user is to board from other vehicles, for example.

A display apparatus provided outside of the vehicle 100 may be adopted for each of the notification elements 103 to 106, for example, and this display apparatus displays the color and/or texture in accordance with the first operation pattern. Such display performed by the display apparatus provided outside of the vehicle 100 is tentatively referred to as “illumination” for the vehicle 100.

Such display outside the vehicle 100 may be driven by an illumination drive unit 132, for example (see FIG. 1). The illumination drive unit 132 is included in the notification drive unit 13. The function of the illumination drive unit 132 is controlled by the function control unit 11.

Visual notification may be performed by the notification elements 101 to 106 in cooperation. The cooperation executed in this manner is also a portion of the first operation pattern.

The overall illumination performed by the notification elements 103 to 106 may form a texture, for example. The overall texture may or may not change over time.

An auditory notification may also be adopted as the vehicle-side notification (first notification). In this case, the auditory notification can be realized by adopting the horn (not shown in FIG. 1). Regarding auditory notification performed using the horn, it is suitable to avoid a situation where the horn is exerting its original function, for example, a situation where the vehicle 100 is travelling. Auditory notification is suitable in a situation where the vehicle 100 is parked, and the user wants to distinguish the vehicle that hat user is to board from other vehicles, for example.

When auditory notification is adopted, one of or both the frequency and sound volume of a horn sound generated by the horn (hereinafter, tentatively referred to as “frequency and/or sound volume”) is determined based on the first operation pattern. The frequency and/or sound volume may or may not change over time. If the frequency and/or sound volume changes over time, such a temporal change is also a portion of the first operation pattern.

Even when the vehicle-side notification (first notification) that uses the first operation pattern is performed through the abovementioned auditory notification, such notification can be realized under control performed by the notification drive unit 13.

### Illustration of Second Operation Pattern

As described above, the second operation pattern is adopted for terminal-side notification (second notification). As shown in FIG. 2, the notification unit 24 of the mobile device 20 includes a vibration unit 241, a display unit 242, an illumination unit 243, and a speaker 244, for example.

When a smartphone is adopted as the mobile device 20, it is possible to use constituent elements that are usually provided in smartphones as the vibration unit 241, the display unit 242, and the speaker 244. “Illumination” of the mobile device 20 refers to display at a position other than that of the display unit 242 of the mobile device 20, such as, display on a frame body (not illustrated).

The vibration unit 241 is driven by a vibration drive unit 231, the display unit 242 is driven by a display drive unit 232, the illumination unit 243 is driven by an illumination drive unit 233, and the speaker 244 is driven by a sound amplification drive unit 234, for example. The vibration drive unit 231, the display drive unit 232, the illumination drive unit 233, the sound amplification drive unit 234 are all included in the notification drive unit 23 (see FIG. 2).

The functions of all of the vibration drive unit 231, the display drive unit 232, the illumination drive unit 233, the sound amplification drive unit 234 are controlled by the function control unit 21, more specifically by the drive control unit 213 included in the function control unit 21.

Various forms of the second operation pattern can be envisioned.

When visual notification is performed, for example, the color and/or texture can be displayed by the notification unit 24. The color and/or texture may or may not change over time. If the color and/or texture changes over time, such a temporal change is also a portion of the second operation pattern.

Visual notification may be performed by the display unit 242 and the illumination unit 243 individually or in cooperation. The cooperation that is executed in this manner is also a portion of the second operation pattern.

The frequency and/or sound volume of a sound generated by one of or both the speaker 244 and the vibration unit 241 is determined based on the second operation pattern when auditory notification is adopted. The frequency and/or sound volume may or may not change over time. If the frequency and/or sound volume changes over time, such a temporal change is also a portion of the second operation pattern.

One of or both the frequency and intensity of vibration generated by the vibration unit 241 (hereinafter, tentatively referred to as “frequency and/or intensity”) are determined based on the second operation pattern when tactual notification is adopted.

The frequency and/or intensity may or may not change over time. If the frequency and/or intensity changes over time, such a temporal change is also a portion of the second operation pattern.

Illustration of Association between First Operation Pattern and Second Operation Pattern

Regarding the vehicle-side notification (first notification) that uses the first operation pattern, for example, a console display is adopted as the notification element 101, and this console display performs display so as to include one of text, symbols, and pictorial symbols for specifying the user carrying the mobile device 20. Also, regarding the terminal-side notification (second notification) that uses the second operation pattern, display is performed so as to include one of text, symbols, and pictorial symbols for specifying the user or the vehicle 100 in which the notification control apparatus 10 that includes the notification element 101 is mounted.

“Vehicle for Mr. or Ms. XX” may be displayed on the notification element 101, and “vehicle for Mr. or Ms. XX has a notice” may be displayed on the display unit 242, for example. The first operation pattern and the second operation pattern when such display is performed are associated with each other so as to specify the same user.

When visual notification is performed as the vehicle-side notification (first notification) that uses the first operation pattern, for example, a temporal change in the color and/or texture adopted for vehicle-side notification (first notification) is synchronized with at least one of the following:

a temporal change in the color and/or texture displayed on one of or both the display unit 242 and the illumination unit 243;

a temporal change in the frequency and/or sound volume of a sound generated by one of or both the vibration unit 241 and the speaker 244; and

a temporal change in the frequency and/or intensity of vibration generated by the vibration unit 241.

Here, “temporal change being synchronized with” refers to an event where a basic cycle of the temporal change in the color and/or texture that is adopted for vehicle-side notification (first notification) based on the first operation pattern is the same as one of or both a basic cycle of the temporal change in the color and/or texture and a basic cycle of the temporal change in the frequency and/or sound volume adopted for terminal-side notification (second notification) based on the second operation pattern. In addition, in specifying the same cycle in this manner, the first operation pattern and the second operation pattern are associated with each other so as to specify the same user.

When a console display is adopted as the notification element 101, and the change in the color is repeated in a cycle T as the vehicle-side notification (first notification) and is not repeated in a period shorter than the cycle T, the cycle T is a basic cycle for the change in the color. The same applies to the change in colors of the display unit 242 and the illumination unit 243.

A case is envisioned where display apparatuses provided outside the vehicle 100 are adopted as the notification elements 103 to 106, and overall display on the notification elements 103 to 106 forms a texture, for example. When the change in the color is repeated in the cycle T in all of the notification elements 103 to 106 so as to be shifted from each other by a period T/4, overall display on the notification elements 103 to 106 form a texture. In such a case, the cycle T is a basic cycle for the change in the texture. The same applies to the changes in the textures of the display unit 242 and the illumination unit 243.

These changes in the color and the texture are included in the temporal change in the color and/or texture.

If a change in the frequency of a sound generated by at least one of the vibration unit 241 and the speaker 244 is repeated in the cycle T, and is not repeated in a period shorter than the cycle T, for example, the cycle T is a basic cycle for the change in the frequency. The same applies to a temporal change in the sound volume. The same applies to a temporal change in the frequency and/or intensity of vibration generated by the vibration unit 241.

The technique for synchronizing such temporal changes using the first operation pattern and the second operation pattern associated with each other can be easily realized with a known control technique. The first operation pattern is information for instructing a temporal change in the color and/or texture in the cycle T, and the second operation pattern is information for instructing a temporal change in at least one of the color and/or texture, the frequency and/or sound volume, and the frequency and/or intensity, in the cycle T, for example.

### Form of Notification That is Based on Distance

Providing a plurality of types of second operation patterns according to the distance between the mobile device 20 and the vehicle 100 that the user is to board is advantageous for the user to recognize the distance between the user and the vehicle 100. When the vehicle that the user is to board is arranged, such a configuration is advantageous for the user to be able to recognize that the user is close to the vehicle even in a situation where the vehicle 100 cannot be visually recognized.

As shown in FIG. 4, when second operation patterns are generated in step S104, a second operation pattern of a type A that is adopted for a short distance and a second operation pattern of a type B that is adopted for a long distance are generated. In transmission of second operation patterns in step S105, the second operation patterns of the type A and the type B are transmitted to the mobile device 20.

As shown in FIG. 5, the second operation patterns of the type A and the type B are received as second operation patterns in step S205, for example.

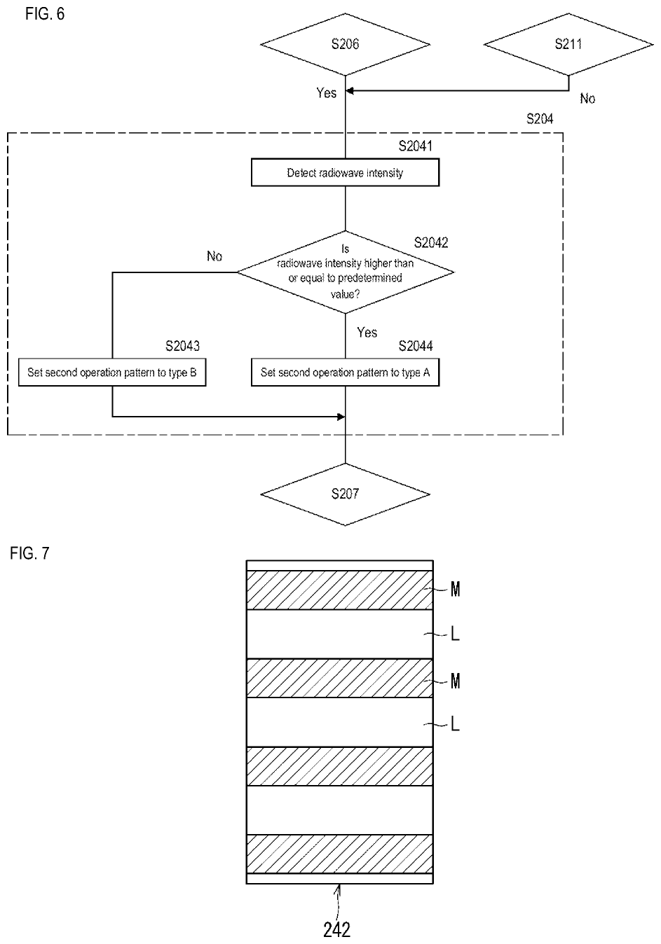

FIG. 6 is a flowchart illustrating processing for changing the form of the terminal-side notification (second notification) in accordance with a distance. This processing is executed in step S204. Step S204 is executed prior to step S207 if the determination in step S206 in the flowchart shown in FIG. 5 is “yes”, or the determination in step S211 is “no”.

In execution of step S204, step S2041 is first executed. In step S2041, the intensity of radiowaves received by the mobile device 20 (hereinafter and in FIG. 6, referred to as “radiowave intensity”) is detected. Radiowaves to be subjected to intensity detection may be a signal transmitted from the notification control apparatus 10 and received through the communication J22 (this signal is transmitted through the communication J12), or may also be a signal transmitted from the notification control apparatus 10 and received through the communication J23 (this signal is transmitted through the communication J13), and such detection of a radiowave intensity can be realized by the communication unit 22 and the function control unit 21 in cooperation. More specifically, step S2041 is executed by the communication circuit 222 and the communication control unit 212 in cooperation, or by the communication circuit 223 and the communication control unit 212 in cooperation.

After step S2041 is executed, step S2042 is executed. In step S2042, a determination is performed as to whether or not the radiowave intensity detected in step S2041 is higher than or equal to a predetermined value. Such a determination can be executed by the information processing unit 211.

If the result of the determination in step S2042 is “no”, in other words if it is determined that the detected radiowave intensity is lower than the predetermined value, it is inferred that the distance between the notification control apparatus 10 and the mobile device 20 is longer than a distance corresponding to the predetermined value. Since the notification control apparatus 10 is mounted in the vehicle 100 and it is envisioned that the user is carrying the mobile device 20, if the determination in step S2042 is “no”, it is inferred that the vehicle 100 is separated by a distance longer than the distance corresponding to the predetermined value when viewed from the user that is to board the vehicle 100. Thus, step S2043 is executed, and the second operation pattern is set to the type B adopted for a long distance.

If the determination in step S2042 is “yes”, in other words, if it is determined that the detected radiowave intensity is higher than or equal to the predetermined value, it is inferred that the distance between the notification control apparatus 10 and the mobile device 20 is shorter than or equal to the distance corresponding to the predetermined value. It is inferred that the vehicle 100 is at the distance corresponding to the predetermined value or is closer than that when viewed from the user that is to board the vehicle 100. Thus, step S2044 is executed, and the second operation pattern is set to the type A that is adopted for a short distance.

Both steps S2043 and S2044 can be performed by the information processing unit 211 or the drive control unit 213. After either step S2043 or S2044 is executed, step S207 is executed. In the processing in step S207, the notification unit 24 is operated based on the type B set in step S2043 or the type A set in step S2044. Due to such processing, the second operation pattern that corresponds to the distance between the notification control apparatus 10 and the mobile device 20 carried by the user is selected from a plurality of types. The notification drive unit 23 causes the notification unit 24 to perform the terminal-side notification (second notification) that uses the selected type of second operation pattern.

Normally, the vehicle 100 approaches the mobile device 20, and thus, when steps S204 and S207 are being repeatedly executed, the result of the determination in step S2042 changes from no to “yes”, and the second operation pattern that is set changes from the type B that is adopted for a long distance to the type A that is adopted for a short distance.

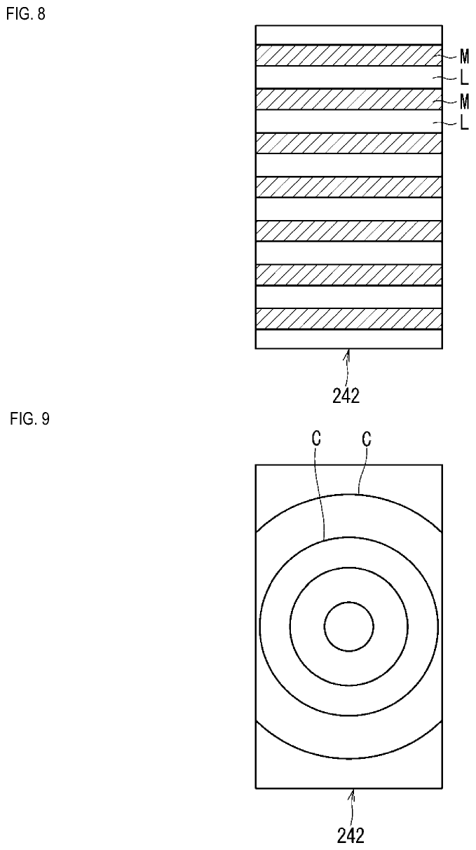

Both FIGS. 7 and 8 are diagrams illustrating the terminal-side notification (second notification) that is performed using the display unit 242. Specifically, a plurality of first portions M and a plurality of second portions L for which the brightness is higher than the first portions M are alternately displayed on the display unit 242, and a so-called stripe texture is displayed on the display unit 242. Hereinafter, the interval at which a first portion M and a second portion L that are adjacent and are repeatedly displayed is referred to as “interval of the stripe texture”.

FIG. 7 illustrates a case where the second operation pattern of the type B is adopted, and FIG. 8 illustrates a case where the second operation pattern of the type A is adopted. The interval of the stripe texture shown in FIG. 8 is smaller than the interval of the stripe texture shown in FIG. 7. The user that visually recognizes the display unit 242 can recognize that the vehicle that the user is to board has approached the user by recognizing that the interval of the stripe texture displayed on the display unit 242 has reduced.

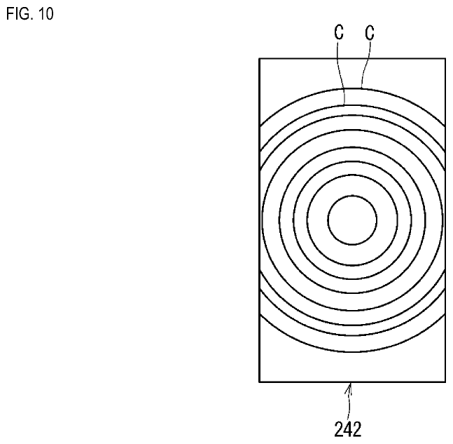

Both FIGS. 9 and 10 are diagrams illustrating the terminal-side notification (second notification) that is performed using the display unit 242. Specifically, a plurality of concentric circles C are displayed on the display unit 242.

FIG. 9 illustrates a case where the second operation pattern of the type B is adopted, and FIG. 10 illustrates a case where the second operation pattern of the type A is adopted. The interval between concentric circles C shown in FIG. 10 are smaller than the interval between concentric circles C shown in FIG. 9. The user that visually recognizes the display unit 242 can recognize that the vehicle that the user is to board has approached the user, by recognizing that the interval between concentric circles C displayed on the display unit 242 have reduced.

### Modified Examples

In both the vehicle-side notification (first notification) and the terminal-side notification (second notification), it is possible to combine visual notification, auditory notification, and tactual notification.

A smartphone can be adopted as the mobile device 20, and the smartphone may also function as an entry key of the vehicle 100.

Regarding whether to set the type A or the type B of second operation pattern, a configuration may also be adopted in which, in place of or in addition to detection of the radiowave intensity in step S2041 and determination of the radiowave intensity in step S2042, the positions of both the notification control apparatus 10 and the mobile device 20 are obtained, and the distance between the notification control apparatus 10 and the mobile device 20 is obtained. Such positions can be obtained using a global positioning system (hereinafter abbreviated as “GPS”) by adopting the communication J11 and the communication J21 that comply with Telematics.

Transmission of the device code executed in step S201 (see FIG. 5) may also be based on the assumption that the distance between the notification control apparatus 10 and the mobile device 20 obtained by the GPS is shorter than a predetermined distance. Such assumption is advantageous in consideration of a fact that, if the distance is long, the notification control apparatus 10 cannot receive the device code even if it is transmitted (see step S101 in FIG. 4).

A form in which temporal changes are synchronized will be illustrated below. Such illustration does not limit the form.

A time point at which the brightness of a color adopted for the vehicle-side notification (first notification) is maximum may match a time point at which the brightness of a color adopted for the terminal-side notification (second notification) is maximum. A time point at which the brightness of a color adopted for the vehicle-side notification (first notification) is maximum may match a time point at which the brightness of a color adopted for the terminal-side notification (second notification) is minimum.

A time point at which the brightness of a color adopted for the vehicle-side notification (first notification) is maximum may match a time point at which the sound volume of a sound adopted for the terminal-side notification (second notification) is maximum. A time point at which the brightness of a color adopted for the vehicle-side notification (first notification) is maximum may match a time point at which the sound volume of a sound adopted for the terminal-side notification (second notification) is minimum.

A time point at which the brightness of a color adopted for the vehicle-side notification (first notification) is maximum may match a time point at which the frequency of a sound adopted for the terminal-side notification (second notification) is maximum. A time point at which the brightness of a color adopted for the vehicle-side notification (first notification) is maximum may match a time point at which the frequency of a sound adopted for the terminal-side notification (second notification) is minimum.

A time point at which the complexity of a texture adopted for the vehicle-side notification (first notification) is maximum may match a time point at which the brightness of a color adopted for the terminal-side notification (second notification) is maximum. A time point at which the complexity of a texture adopted for the vehicle-side notification (first notification) is maximum may match a time point at which the brightness of a color adopted for the terminal-side notification (second notification) is minimum.

A time point at which the complexity of a texture adopted for the vehicle-side notification (first notification) is maximum may match a time point at which the sound volume of a sound or vibration adopted for the terminal-side notification (second notification) is maximum. A time point at which the complexity of a texture adopted for the vehicle-side notification (first notification) is maximum may match a time point at which the sound volume of a sound or vibration adopted for the terminal-side notification (second notification) is minimum.

A time point at which the complexity of a texture adopted for the vehicle-side notification (first notification) is maximum may match a time point at which the frequency of a sound or vibration adopted for the terminal-side notification (second notification) is maximum. A time point at which the complexity of a texture adopted for the vehicle-side notification (first notification) is maximum may match a time point at which the frequency of a sound or vibration adopted for the terminal-side notification (second notification) is minimum.

A constituent element other than the function control unit 11 may also generate the first operation pattern and the second operation pattern.

Types of second operation pattern are not limited to two types, namely the type A and the type B. A form of notification corresponding to a distance can be more accurately performed by adopting a larger number of types.

When visual notification is performed, at least one of the luminance, brightness, hue, and saturation of a color that is realized by the type A may also be made higher than that of a color that is realized by the type B. A configuration may also be adopted in which, for example, a color realized by the type A is selected from warm colors, and a color realized by the type B is selected from cold colors.

When auditory notification is performed, the frequency and/or intensity of a sound realized by the type A may also be made higher than the frequency and/or intensity of a sound realized by the type B.

Similarly to the terminal-side notification (second notification), also in the vehicle-side notification (first notification), a different form may be adopted in accordance with the distance between the notification control apparatus 10 and the mobile device 20.

Note that the configurations described in the above embodiments and modified examples can be combined as appropriate, unless there is mutual inconsistence.

The above-mentioned “information” can be transferred and processed as data. Therefore, “information” to be subjected to at least one of both transfer and processing can be replaced with “data”.

Although the present disclosure has been described above in detail, the above description is illustrative and non-limiting in all aspects. It is understood that an infinite number of modified examples that are not illustrated can be envisioned without departing from the scope of the present disclosure.

1. A notification control apparatus comprising:
a notification drive unit, a communication unit and a function control unit,
the notification drive unit being configured to cause a notification unit provided in a vehicle and configured to perform vehicle-side notification that is recognizable from the outside, to perform the vehicle-side notification using a first operation pattern;
the communication unit being configured to transmit a second operation pattern that is associated with the first operation pattern and is provided as a predetermined operation pattern, to a mobile terminal that has a notification function of performing terminal-side notification that uses the predetermined operation pattern; and
the function control unit being configured to control a function of the communication unit and a function of the notification drive unit.

2. The notification control apparatus according to claim 1, wherein a pair of the first operation pattern and the second operation pattern is generated in a random manner.

3. The notification control apparatus according to claim 1, wherein the communication unit performs communication for performing mutual authentication with the mobile terminal, and
the function control unit causes the communication unit to transmit the second operation pattern to the mobile terminal for which the authentication has been achieved.

4. The notification control apparatus according to claim 1, wherein, after transmitting the second operation pattern to the mobile terminal,
the communication unit transmits, to the mobile terminal, a start trigger, which is an instruction to start the terminal-side notification that uses the second operation pattern.

5. The notification control apparatus according to claim 4, wherein, when a predetermined time has elapsed from when the communication unit transmitted the start trigger to the mobile terminal, the function control unit causes the notification drive unit to end the vehicle-side notification.

6. The notification control apparatus according to claim 1, wherein, when the communication unit receives an end instruction from the mobile terminal, the function control unit causes the notification drive unit to end the vehicle-side notification.

7. The notification control apparatus according to claim 1, wherein, if a predetermined condition is satisfied in the vehicle, the communication unit transmits, to the mobile terminal, an end trigger that is an instruction to end the terminal-side notification that uses the second operation pattern.

8. The notification control apparatus according to claim 7, wherein, after the communication unit has transmitted the end trigger to the mobile terminal, the function control unit causes the notification drive unit to end the vehicle-side notification.

9. The notification control apparatus according to claim 1, wherein there are a plurality of types of second operation patterns in accordance with a distance between the notification control apparatus and the mobile terminal.

10. A mobile terminal comprising:
a second communication unit configured to receive the second operation pattern from the notification control apparatus according to any one of claims 1 to 8;
a second notification unit configured to perform the terminal-side notification using a predetermined operation pattern;
a second notification drive unit configured to cause the second notification unit to perform the terminal-side notification using the second operation pattern as the predetermined operation pattern; and
a second function control unit configured to control a function of the second communication unit and a function of the second notification drive unit.

11. The mobile terminal according to claim 10,
wherein there are a plurality of types of second operation patterns in accordance with a distance between the vehicle and the mobile terminal, and
the second notification drive unit causes the second notification unit to perform the terminal-side notification that uses the second operation pattern selected from the plurality of types in accordance with the distance.

12. A notification method comprising:
generating a first operation pattern and a second operation pattern in association with each other;
causing a notification unit provided in a vehicle and configured to perform vehicle-side notification that is recognizable from the outside, to perform the vehicle-side notification using the first operation pattern; and
transmitting the second operation pattern as a predetermined operation pattern to a mobile terminal that has a notification function of performing terminal-side notification that uses the predetermined operation pattern.
